(19) United States
(12) Patent Application Publication
(10) Pub. No.: US 2026/0236831 A1
(43) Pub. Date: Aug. 13, 2026

(54) RETRIEVER MACHINE-LEARNING MODEL TRAINING DATA GENERATION AND IMPLEMENTATION

(71) Applicant: Adobe Inc., San Jose, CA (US)

(72) Inventors: Soumya Suvra Ghosal, College Park, MD (US); Soumyabrata Pal, Bengaluru (IN); Koyel Mukherjee, Bangalore (IN); Meghanath M Y, Pittsburgh, PA (US)

(73) Assignee: Adobe Inc., San Jose, CA (US)

(21) Appl. No.: 19/053,257

(22) Filed: Feb. 13, 2025

(51) Int. Cl. G06N 20/00; G06F 40/263

(52) U.S. Cl. CPC G06N 20/00; G06F 40/263

(57) ABSTRACT

A query system is described that supports retriever machine-learning model training data generation and implementation. The retriever machine-learning model is configured to retrieve examples for inclusion in a prompt formed from an input query that provide context for the query in performance of a corresponding task. The query system, in one or more examples, implements an alternating minimization technique for example selection that enhances in-context learning (ICL) performance for resources having few initial examples, e.g., for an initial resource. The query system is also configurable to incorporate example diversity that improves generalization and reduces bias in the retriever machine-learning model used to select the examples.

### BACKGROUND

Machine-learning models support a variety of functionalities. However, in some real-world scenarios these functionalities are confronted with data scarcity during training. Data scarcity limits accuracy of the machine-learning models once trained, makes the machine-learning models susceptible to hallucinations, results in inaccuracies on “unseen data,” and so forth.

Data scarcity, for instance, can lead to overfitting, where the machine-learning model performs well on training data but poorly on the unseen data. Data scarcity also hampers the machine-learning model's ability to generalize, resulting in biased or incomplete predictions. Additionally, insufficient amounts of training data can cause the machine-learning models to misinterpret patterns, leading to erroneous outputs. Consequently, machine-learning models that are trained with an insufficient amount of training data may fail for an intended purpose due to production of inaccurate results and a corresponding inefficient use in computational resources in generating the inaccurate results.

### SUMMARY

A query system is described that supports retriever machine-learning model training data generation and implementation. The retriever machine-learning model is configured to retrieve examples for inclusion in a prompt formed from an input query that provide context for the query in performance of a corresponding task. The query system, in one or more examples, implements an alternating minimization technique for example selection that enhances in-context learning (ICL) performance for resources having few initial examples, e.g., for an initial resource. To do so, the query system utilizes auxiliary examples from an auxiliary resource and applies multi-task learning techniques to facilitate cross-resource retrieval. The query system is also configurable to incorporate example diversity that improves generalization and reduces bias in the retriever machine-learning model used to select the examples.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ retriever machine-learning model training data generation and implementation techniques described herein

FIG. 2 depicts an example implementation of in-context learning.

FIG. 3 depicts an example implementation of example retrieval for few-shot learning.

FIG. 4 depicts a system in an example implementation of training data generation using a retrieval system of FIG. 1 in greater detail.

FIG. 5 is a flow diagram depicting an algorithm as a step-by-step procedure in an example implementation of operations performable for accomplishing a result of training data generation for training a retriever machine-learning model to generate an example for inclusion in a prompt based on an input query.

FIG. 6 depicts a system in an example implementation of training a retriever machine-learning model based on the training data generated in FIG. 4 in greater detail.

FIG. 7 depicts a system in an example implementation of operation of the trained retriever machine-learning model of FIG. 6.

FIG. 8 is a flow diagram depicting an algorithm as a step-by-step procedure in an example implementation of operations performable for accomplishing a result of training a retriever machine-learning model to select an example for inclusion in a prompt based on an input query.

FIG. 9 depicts an example of an algorithm usable by the system of FIG. 6 to implement training a retriever machine-learning model.

FIG. 10 depicts a system in an example implementation showing training of a machine-learning model of FIGS. 1 and 6 in greater detail.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Machine-learning models support a variety of functionalities. In one such example, few-shot learning capabilities are supported in which a machine-learning model is trained to make predictions based on a relatively small number of labeled examples. Few-shot learning contrasts with conventional supervised learning techniques that involve training using large training datasets, e.g., thousands and even millions of examples.

In-context learning involves use of prompt having examples to demonstrate a task to be performed by the machine-learning model. The machine-learning model then makes predictions in this instance based on this context without further parameter optimization. Thus, in-context learning leverages the machine-learning model's ability to infer patterns and relationships from the given examples, enabling the machine-learning model to perform an associated task well even with minimal data. Together, few-shot and in-context learning enable the machine-learning model to generalize based on limited data and adapt quickly to new tasks and previously unseen data.

In-context learning accuracy, however, is highly dependent on which examples are selected for inclusion as part of the prompt, especially in a few-shot learning scenario. Because of this, accuracy of these techniques often fails in real-world scenarios where the scarcity of ground-truth training data complicates a selection process used to select relevant examples for inclusion in the prompt.

Accordingly, a query system is described that supports retriever machine-learning model training data generation and implementation. The retriever machine-learning model is configured to retrieve examples for inclusion in a prompt formed from an input query that provide context for the query in performance of a corresponding task. The prompt, when processed by a machine-learning model (e.g., a large language model (LLM)), is then provided with context that increases accuracy in a query result through increased accuracy supported in the example generated using the techniques described herein.

The query system, in one or more examples, implements an alternating minimization technique for example selection that enhances in-context learning (ICL) performance for resources having few initial examples, e.g., for an initial resource. To do so, the query system utilizes auxiliary examples from an auxiliary resource and applies multi-task learning techniques to facilitate cross-resource retrieval. The query system is also configurable to incorporate example diversity that improves generalization and reduces bias in the retriever machine-learning model used to select the examples. In this way, the query system addresses technical challenges of data scarcity in use of machine-learning models, such as in-context learning in a few-shot learning scenario. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Retriever Machine-Learning Model Environment

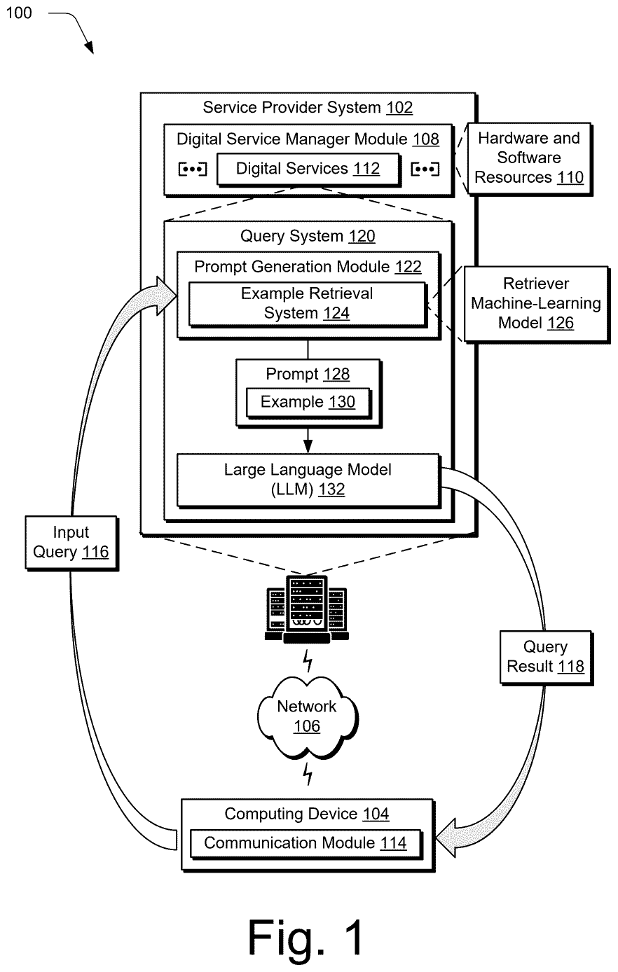

FIG. 1 is an illustration of a digital medium environment 100 in an example implementation that is operable to employ retriever machine-learning model training data generation and implementation techniques described herein. The illustrated environment 100 includes a service provider system 102 and a computing device 104 that are communicatively coupled, one to another, via a network 106. Computing devices are configurable in a variety of ways.

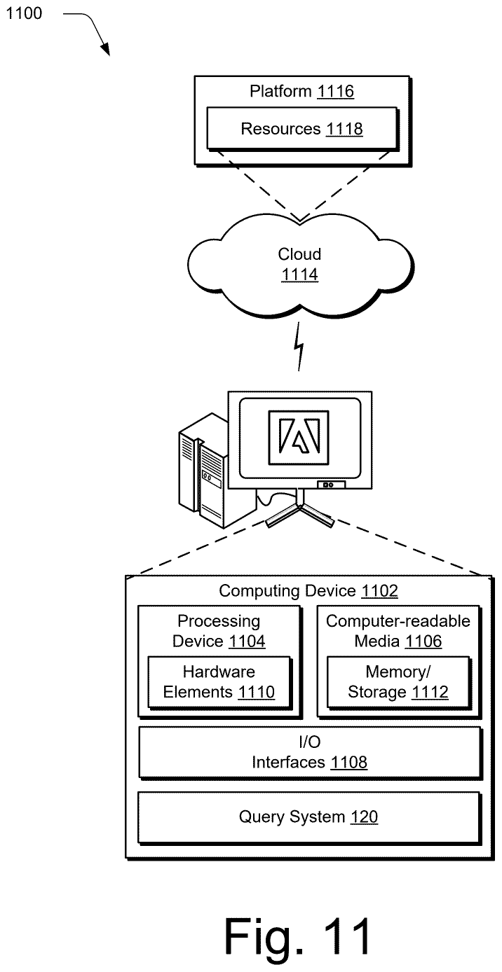

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 11.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, an input query 116 is used as a basis by the service provider system 102 to generate a query result 118 using a query system 120. The query system 120 is representative of a variety of functionalities that leverage machine learning to perform associated tasks. Examples of these functionalities include digital search, translation, text retrieval, generative artificial intelligence (AI), and so on. Although illustrated as implemented by the digital services 112 of the service provider system 102, the query system 120 may also be implemented locally on the computing device 104, e.g., by the communication module 114.

The query system 120 is configurable to supplement the input query 116 for processing by a machine-learning model. To do so, the query system 120 includes a prompt generation module 122 that includes an example retrieval system 124 leveraging a retriever machine-learning model 126. The prompt generation module 122 is configured to generate a prompt 128 based on the input query 116 and the retriever machine-learning model 126 is configured to retrieve an example 130 for inclusion as part of the prompt 128. The example 130 is included to provide context to the input query 116 as part of the prompt 128 for processing by at least one machine-learning model, an example of which is illustrated as large language model (LLM 132) although other examples are also contemplated.

Recent advancements in Large Language Models (LLMs) have expanded an ability of the models to perform a variety of tasks. For downstream tasks with limited labeled data, few-shot learning and in-context learning (ICL) have emerged as a powerful and practical approach for text generation. In-context learning operates by providing the LLM 132 with a prompt 128 that includes an input query 116 of task-specific instructions and an example 130 (e.g., demonstration) to guide the LLM 132 for a specific input query 116. While in-context learning is computationally efficient as it does not rely on parameter updates, in-context learning faces a variety of technical challenges when labeled data is scarce, e.g., for low-resource human languages.

The first technical challenge relates to relevance. For a learning task with limited data, a small size of the available example pool may result in a lack of relevant examples to effectively guide the LLM 132. For in-context learning, this scarcity in operation degrades performance, as the quality of examples is a driving factor in accuracy of the query result 118. Poor example selection, for instance, may lead to performance worse than zero-shot scenarios, while on the other hand optimal selection may achieve near state-of-the-art results.

A second technical challenge involves diversity of examples provided as part of the prompt. Conventional example selection techniques (e.g., random selection or retrieval of semantically similar examples), for instance, often struggle to account for diversity among the selected examples, which can further limit performance. Therefore, a diverse set of selected examples in the prompt is usable to significantly improve generalization supported by the LLM 132.

To address these and other technical challenges, the query system 120 is configured to enhance performance of the LLM 132 in scenarios involving limited resources usable as the example 130 as part of the prompt 128. The query system 120, for instance, implements an in-context learning (ICL) techniques to enhance LLM 132 performance in low-resource scenarios, e.g., human languages having limited examples including low-resource human languages (e.g., some Indic human languages such as Tibetan) in the following examples. The query system 120 is configurable to identify one or more guiding examples for insertion into the prompt 128 without modifying parameters of the LLM 132.

To do so, the retriever machine-learning model 126 is trained to extract a set of examples based on the input query 116. In one or more examples, the query system 120 is configured to leverage initial resource examples from an initial resource along with auxiliary resource examples from an auxiliary resource. The initial resource, for instance, may correspond to a low-resource human language and the auxiliary resource corresponds to a relatively high-resource human language, e.g., having a significant number of examples.

In a human language example of resources, for instance, in real-world scenarios LLMs are predominantly pre-trained on English texts, resulting in significant performance disparities when applied to low-resource, non-English languages. The scarcity of ground-truth paired data in many low-resource languages makes text generation by the LLM 132 particularly challenging, as fine-tuning of the LLM 132 is not feasible in such settings. This issue is especially evident in lesser-known Indic languages, such as Tibetan. Accordingly, one scenario addressed by the query system 120 in the following discussion involves downstream generation tasks with low-resource human languages in order to improve accessibility of the LLM 132 although other machine learning tasks are also contemplated.

For a specific input text generation task in a low-resource human language, a variety of techniques may be employed to enhance machine-learning model performance. First, example banks from closely related, relatively high-resource human languages may be utilized to provide relevant guidance, improving LLM performance on low-resource tasks. As further described below, an initial step may involve an algorithmic approach for an input low-resource task to select relevant high-resources with associated example banks. Second, the query system 120 is configurable to adapt data-scarce multi-task learning techniques to align individual retriever machine-learning models trained for a respective resource into a shared representation space, enabling cross-resource retrieval. Third, diversity is incorporated in the selected examples by the query system 120 to improve generalization and reduce bias during generation. Experimental results indicate that the query system 120 significantly improves generation performance in a variety of tasks compared to conventional baseline approaches for example selection, further discussion of which is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Training-Data Generation

The following discussion describes training data generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

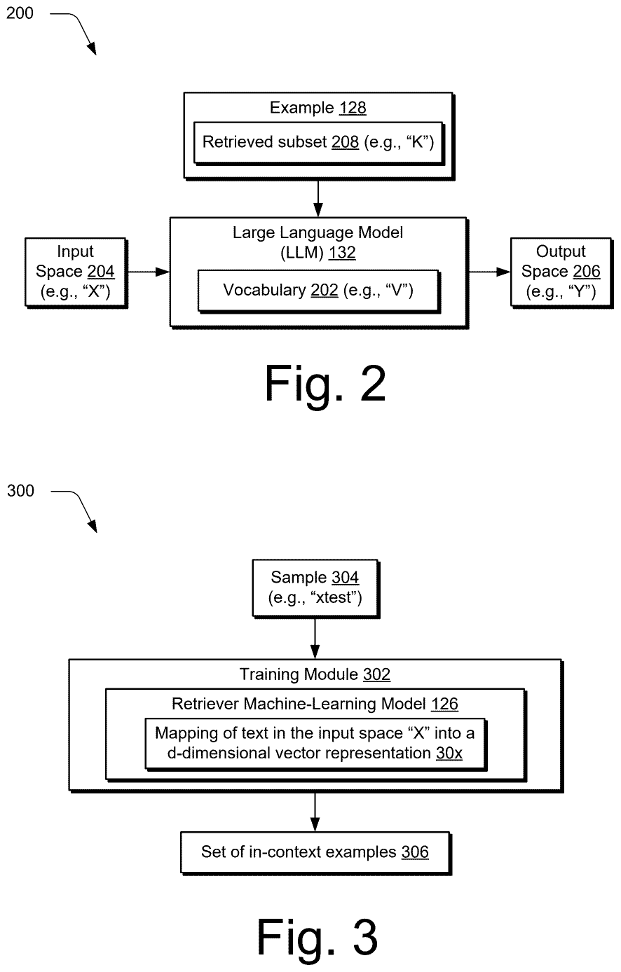

FIG. 2 depicts an example implementation 200 of in-context learning. In-context learning (ICL) harnesses an ability of language models to learn and infer new tasks without parameter updates. Expressed mathematically, an LLM 132 “π_{LM}” operates with a vocabulary 202 “V.” For a downstream generation task, an input space 204 is denoted as “X” and the output 206 space as “Y.”

For a given input query “xₜₑₛₜ∈X” and a retrieved subset 208 of “K” input-output pairs

$$“ {\{ ( {x}_{i} , {y}_{i} ) \}}_{i = 1}^{K} ∈ 𝒳 \times 𝒴 ”$$

that describe the intended task, in-context learning produces an output “yₜₑₛₜ∈Y” as follows:

$${y}_{test} \sim {π}_{LM} ( \cdot \vert {x}_{1} , {y}_{1} , {x}_{2} , {y}_{2} , … , {x}_{K} , {y}_{K} , {x}_{test} )$$

The symbol “~” represents a variety of sampling techniques, examples of which include greedy sampling, top-p sampling, top-k Sampling, and beam search. Each in-context example “aᵢ=(xᵢ, yᵢ)∈X×Y” is selected from a training set example bank of

$$“ D = {\{ ( {x}_{i} , {y}_{i} ) \}}_{i = 1}^{N} ”$$

input/output sequences.

FIG. 3 depicts an example implementation 300 of example retrieval for few-shot learning. In this example, a training module 302 is tasked with training the retriever machine-learning model 126 “R_{φ}(xₜₑₛₜ, D)” parameterized by “φ,” that retrieves a set of in-context examples

$$“ {\{ {a}_{i} \}}_{i = 1}^{K} ⊂ 𝒟 ”$$

given a sample 304 “xₜₑₛₜ” where typically “K«N.” The following expression “φ: (X∪Y)*→R^{d}” represents an embedding function that maps text in the input space 204 into a d-dimensional vector representation. These vector representations are subsequently used to measure and determine sample similarity, one to another, as part of generating a set of in-context examples 306.

In an example involving relevance-based fine tuning, the training module 302 is configured to adjust operation of the retriever machine-learning model 126 to promote example diversity. The retriever machine-learning model 126 is trained by the training module 302 using a labeled dataset curated from the training data, which is optimized to select examples that serve as effective prompts through ensuring diversity in the samples selected.

To do so, for each sample “(x,y)∈D” a candidate set

$$“ 𝒜 = {\{ {a}_{i} \}}_{i = 1}^{F} ”$$

is generated, where “aᵢ∈D/(x,y).” The candidate set is selectable using an unsupervised “BM25” retriever that is configured to retrieve “K” examples having a closest vector embedding to “φ(x).” Next, each candidate example “aᵢ∈A” is scored using a language model “π_{scorer}” based on relevance to the sample “(x,y)” as follows:

$$s ( {a}_{i} ; ( x , y ) ) = {π}_{Scorer} ( y \vert {a}_{i} , x )$$

A candidate example is selected for the sample “(x,y)” as “ã=argmaxₐⱼ s(aⱼ; (x,y)).” The retriever machine-learning model 126 is then fine-tuned to optimally rank candidate examples (e.g., align with ranking induced by “π_{scorer}”) by minimizing a negative log likelihood under software loss as follows:

$${min}_{ϕ} {ℒ}_{rel} ( 𝒟 ; ϕ ) = \frac{1}{N} {\sum }_{i = 1}^{N} ℓ ( {x}_{i} , {𝒜}_{i} )$$

$$ℓ ( x , 𝒜 ; ϕ ) = - log \frac{{e}^{sim ( x , \tilde{a} )}}{{\sum }_{{a}_{i} ∈ 𝒜} {e}^{sim ( {x}_{i} , {a}_{i} )}}$$

where “sim (aᵢ,aⱼ)=φ(aᵢ)^{T}φ(aⱼ)” is a measure of the cosine similarity between the embeddings.

In one or more implementations, a determinational point process (DPP) framework is employed to rank subsets of examples, rather than individual examples. The determinational point process framework may be used to promote diversity within a set of retrieved in-context examples. Mathematically, a point process “P” is a determinational point process if, for a random subset “Y” drawn according to “P,” the probability that a subset “S” is contained within “Y” is given by:

$${\sum }_{k ∈ \{ i , j \}} log {ϕ ( {a}_{k} )}^{T} ϕ ( {x}_{test} ) + log {ϕ ( {a}_{i} )}^{T} ϕ ( {a}_{j} )$$

where “φ(aᵢ)^{T}φ(xₜₑₛₜ)∈ [symbol] ⁺” measures relevance of “aᵢ” to input “xₜₑₛₜ” and “φ(aᵢ)^{T}φ(aⱼ)” measures the similarity between the “i^{th}” and “j^{th}” example.

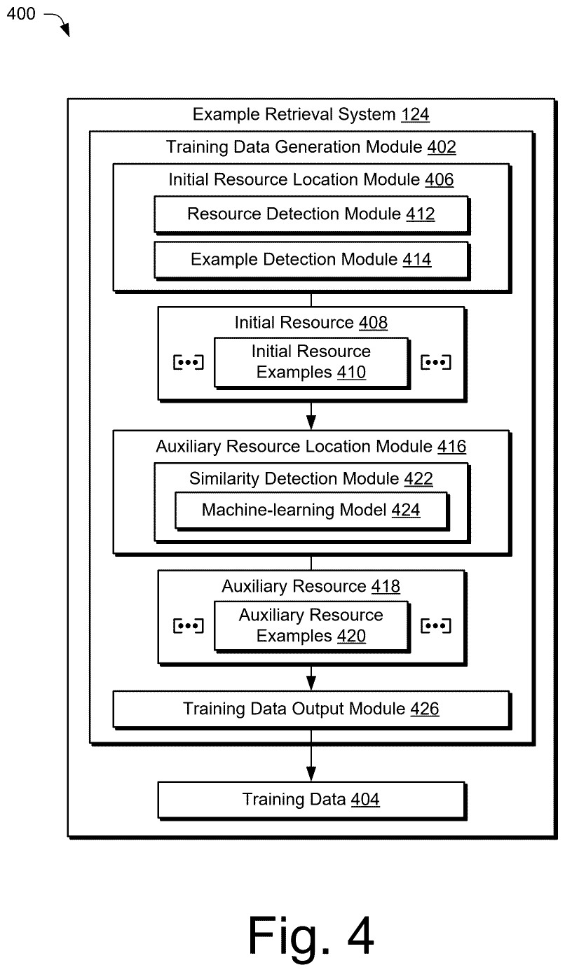

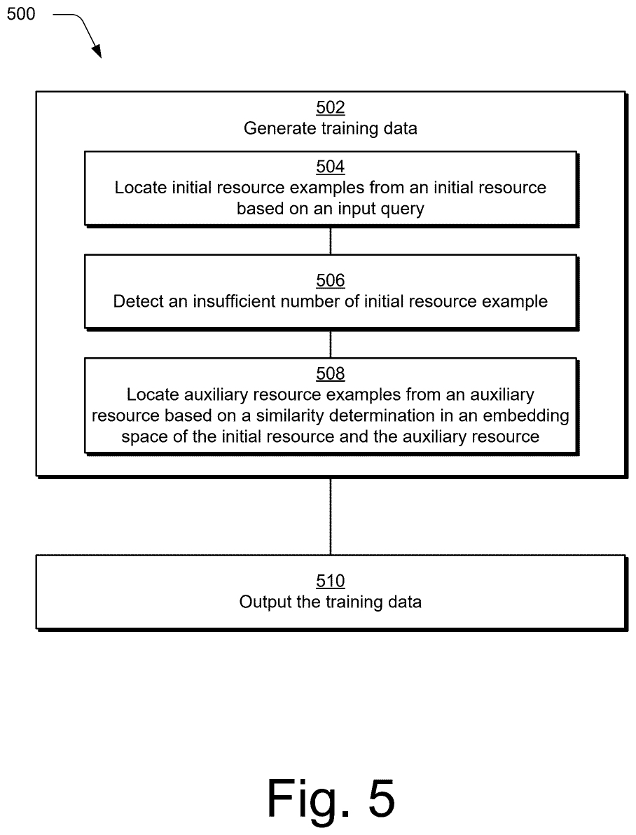

FIG. 4 depicts a system 400 in an example implementation of training data generation using the retrieval system 124 of FIG. 1 in greater detail. FIG. 5 is a flow diagram depicting an algorithm 500 as a step-by-step procedure in an example implementation of operations performable for accomplishing a result of training data generation for training a retriever machine-learning model to generate an example for inclusion in a prompt based on an input query. In the following discussion, reference is made in parallel to FIGS. 4 and 5.

The example retrieval system 124 as illustrated includes a training data generation module 402 configured to generating training data 404 (block 502) usable to train the retriever machine-learning model 126 to retrieve an example 130 for inclusion with an input query 116 in a prompt 128. To enhance performance of the LLM 132 on resources that have limited amounts of examples, the example retrieval system 124 is configured to implement a framework that: (1) identifies closely related high-resource human languages and leverages associated example banks, (2) iteratively refines retriever machine-learning model 126 embeddings “Rφ,” and (3) incorporates diversity-based finetuning of the retriever machine-learning model 126 “Rφ” to rank subsets of in-context examples for a given input query 116.

To begin in this example, the retrieval system 124 employs an initial resource location module 406 to locate an initial resource 408 and initial resource examples 410 from that initial resource 408 based on an input query (block 504). A resource detection module 412, for instance, detects a type of resource associated with the input query, e.g., a human language corresponding to the input query 116, a particular machine-learning task to be performed, and so on. In an implementation, an example detection module 414 is also employed to detect whether a sufficient number of initial resource examples 410 are available for training the retriever machine-learning model 126, e.g., using a threshold number.

In this example, the example detection module 414 detects that there is an insufficient number of initial resource examples available (block 506), i.e., a sufficient number is unavailable. In response, the example detection module 414 prompts an auxiliary resource location module 416 to locate an auxiliary resource 418 and auxiliary resource examples 420 based on a similarity determination in an embedding space of the initial resource and the auxiliary resource (block 508). The auxiliary resource location module 416, for instance, includes a similarity detection module 422 that employs a machine-learning module 424 to generate embeddings of the initial resource and a plurality of auxiliary resources to select one or more auxiliary resources based on similarity in the embedding space, e.g., Cosine similarity.

As previously described, availability of a limited number of examples for a resource pose significant technical challenges for machine-learning models, particularly in specialized domains or less common languages. Low-resource Indic human languages exemplify this problem, as these languages constitute a small fraction of the pre-training data used in real-world scenarios for large language models (LLMs). Consequently, an LLM 132 may exhibit suboptimal performance on generation tasks in these low-resource languages.

To address these technical challenges, the example retrieval system 124 proposes leveraging auxiliary resources, such as relatively high-resource Indic languages (e.g., Hindi and Bengali) as auxiliary datasets. The approach involves selecting auxiliary languages closely related to the target low-resource Indic language. For each low-resource language, the similarity detection module 422 computes a Cosine similarity between the embeddings of the low-resource language and those of candidate auxiliary languages. An auxiliary language is included in the dataset if its similarity score exceeds a predetermined threshold parameter, e.g., “δ.” By incorporating examples from related high-resource languages, the example retrieval system 124 provides the LLM 132 with additional context and relevant guidance, thereby improving operation of the LLM 132 on input queries in the low-resource language. In an implementation, selection of successive auxiliary resources continues until a threshold number of training examples is obtained to accurately train the retriever machine-learning model 126. Once a sufficient number of training examples from the initial resource 408 and the auxiliary resource 418 are obtained, the training data output module 426 is then employed to output the training data 404 (block 510) to train the retriever machine-learning model 126 as further described in the following example.

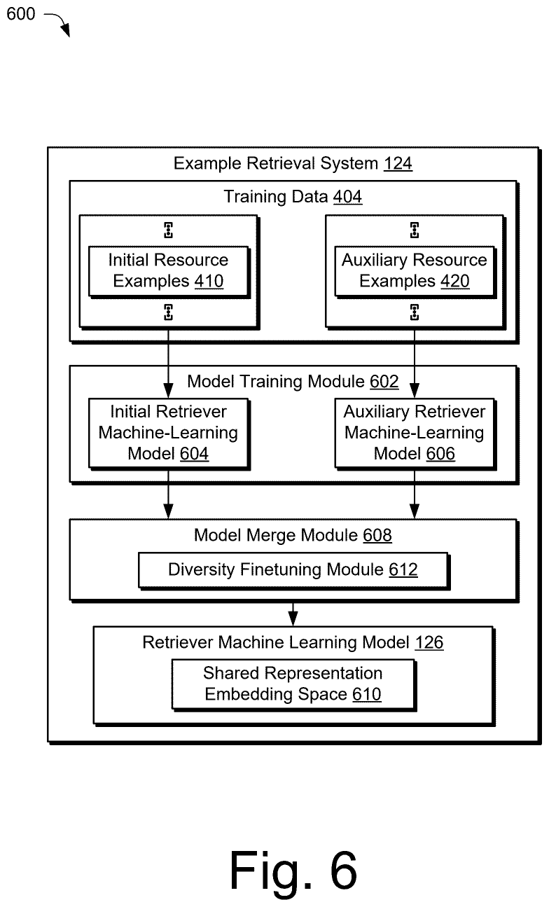

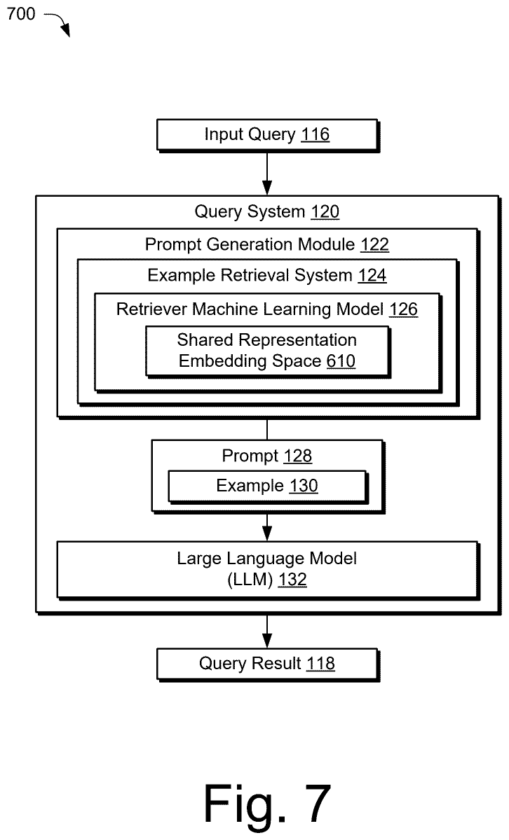

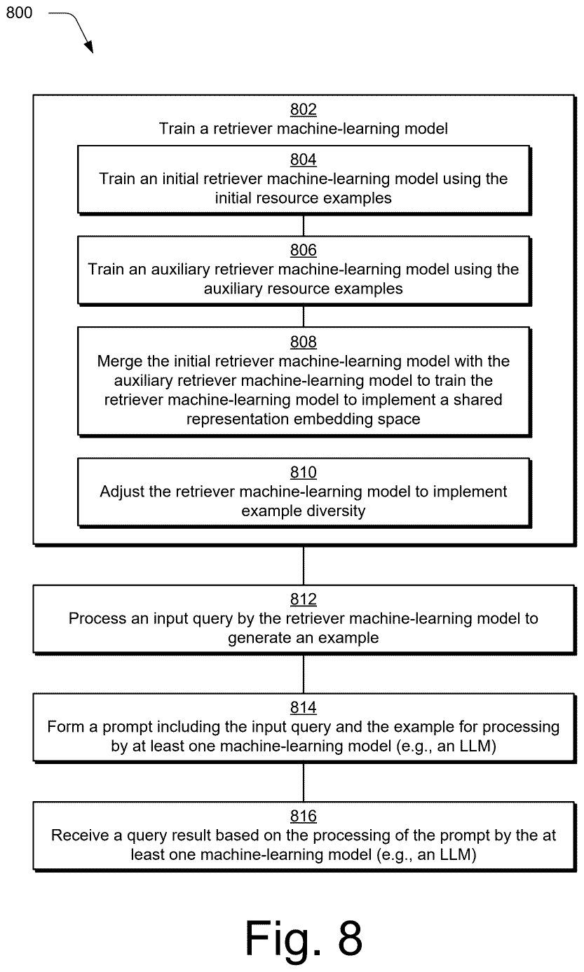

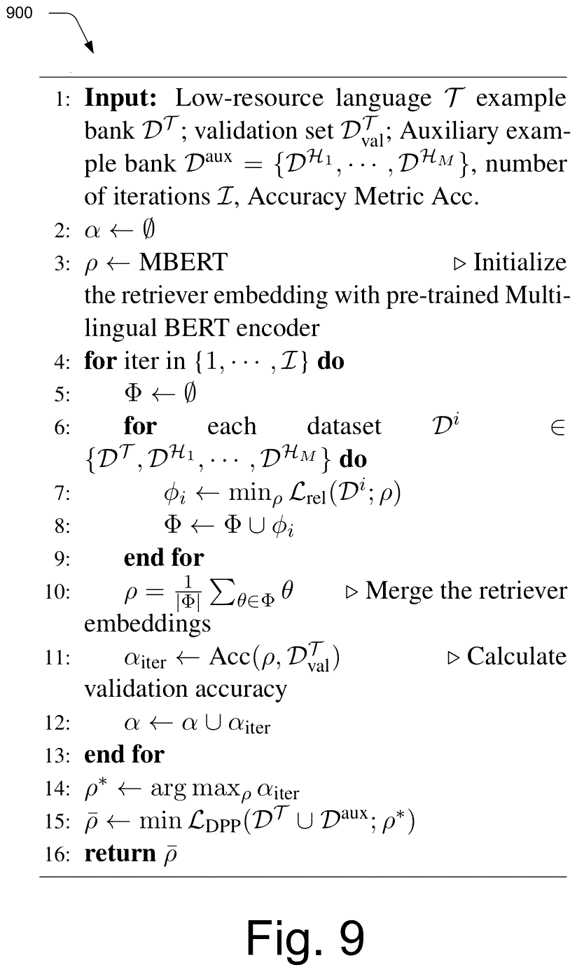

FIG. 6 depicts a system 600 in an example implementation of training a retriever machine-learning model 126 based on the training data generated in FIG. 4 in greater detail. FIG. 7 depicts a system 700 in an example implementation of operation of the trained retriever machine-learning model 126 of FIG. 6. FIG. 8 is a flow diagram depicting an algorithm 800 as a step-by-step procedure in an example implementation of operations performable for accomplishing a result of training a retriever machine-learning model 126 to select an example for inclusion in a prompt based on an input query. FIG. 9 depicts an example of an algorithm 900 usable by the system 600 of FIG. 6 to implement training a retriever machine-learning model. In the following discussion, reference is made in parallel to FIGS. 6 through 9.

To begin in relation to FIG. 6, training data 404 that includes the initial resource examples 410 and the auxiliary resource examples 420 is received by a model training module 602 of the example retrieval system 124. The example retrieval system 124 is then tasked with training the retriever machine-learning model 126 (block 802). To do so, the model training module 602 trains an initial retriever machine-learning model 604 using the initial resource examples 410 (block 804) and an auxiliary retriever machine-learning model 606 using the auxiliary resource examples 420 (block 806). The initial retriever machine-learning model 604 is merged with the auxiliary retriever machine-learning model 606 by a model merge module 608 to train the retriever machine-learning model 126 to implement a shared representation embedding space 610 (block 808). Fine tuning of the retriever machine-learning model 126 may also be performed through use of a diversity finetuning module 612 to promote example diversity and further described below.

Consider a scenario in which the resources correspond to human languages. The initial resource 408 includes an example bank of a low-resource target language “T” as

$$“ {𝒟}^{𝒯} = {\{ ( {x}_{i} , {y}_{i} ) \}}_{i = 1}^{N} , ”$$

the selected set of auxiliary languages as “H=H₁, . . . , H_{M}” and the auxiliary example banks as “D^{aux}=D^{H1}, . . . , D^{HM}.” In an implementation, a number of high-resource auxiliary example banks “M” is determined by a threshold parameter “δ.”

In this example, the retriever machine-learning model 126 as a single machine learning model is trained “R_{ρ}(xₜₑₛₜ, D^{aux}∪ D” however technical challenges remain in that both the shared representation space for each of the example banks combined and the parameter weights “φ” are unknown. At the same time, the retriever machine-learning model 126 is tasked with capturing the specific traits of each individual human language.

Accordingly, in this example the model training module 602 is configured to implement an alternating minimization (AM) framework that alternately performs the following two steps successively until convergence is reached. First, the model training module 602 fine-tunes relevance based retrievers “{R_{φi}}ᵢ” on each of several selected languages by retraining, solely, on an associated resource (e.g., example bank) associated with the corresponding language. In this way, the machine-learning model 604 and the auxiliary retriever machine-learning model 606 individually gain language specific knowledge associated with the corresponding language. In an implementation, each of the individual retriever machine-learning models of the model training module 602 “{R_{φi}}ᵢ” is initialized with pre-trained multilingual BERT encoder weights at the beginning of a first iteration. In subsequent iterations, each of the individual retrievers is initialized with shared parameter weights “ρ.”

The model merge module 608 is then employed to merge the individual retriever machine-learning models trained by the model training module 602 merges the individual retrievers “{R_{φi}}ᵢ” into a single retriever machine-learning model 126 “Rρ,” e.g., by simple parameter averaging to obtain a shared representation embedding space 610 that supports cross-language retrieval. The alternating minimization algorithm alternately fine tunes the individual retriever machine-learning models on language-specific example bank and creates a merged retriever enabling a shared representation space for “I” iterations. The machine-learning model with the highest validation accuracy on the target language “T” after “I” iterations is denoted as “ρ*” in the following discussion. As a result, the retriever machine-learning model 126 “Rρ” encapsulates the diverse knowledge learned by each individual retriever machine-learning model, e.g., the machine-learning model 604 and auxiliary retriever machine-learning model 606.

In an implementation, the retriever machine-learning model 126 is also adjusted as part of training by a diversity finetuning module 612 to implement example diversity (block 810). A technical challenge involved in relevance-based finetuning is that the in-context examples are retrieved solely based on relevance, thereby ignoring diversity and inter-relationship among the selected examples. To address this technical challenge, the DPP framework is leveraged to enhance diversity within the retrieved in-context examples.

In one or more examples, a final version of the retriever machine-learning model 126 is obtained by fine-tuning “ρ*” on the merged dataset “ [symbol] = [symbol] ∪ [symbol] ^{aux}.” Specifically, for each sample “xᵢ, yᵢ∈\tilde{D},” a subset of “Eᵢ” in-context examples are retrieved from “\tilde{D}.” Out of the “Eᵢ” subsets, a positive subset

$$“ {E}_{i}^{( x )} ”$$

is selected using a maximum a posteriori (MAP) sampling from a kernel matrix “Z.” The other “Eᵢ−1” negative subsets

$$“ {E}_{i}^{( - )} ”$$

are selected using non-replacement random sampling, without including repeating examples in each subset. Based on these ground-truth sets, the retriever is fine-tuned using the following loss:

$${ℓ}_{i} {\sum }_{( {E}_{i}^{( + )} , {E}_{i}^{( + )} ) ∈ {ℰ}_{i}} max \{ 0 , log det ( {Z}_{{E}_{i}^{( - )}} ) - log det ( {Z}_{{E}_{i}^{( + )}} ) \} ,$$

$${ℒ}_{DPP} = \frac{1}{\tilde{N}} {\sum }_{i = 1}^{\tilde{N}} {ℓ}_{i} ,$$

where “Ñ” is a number of samples in “\tilde{D}.”

As shown in FIG. 6, the retriever machine-learning model 126, once trained, is then usable to process an input query 116 to generate an example 130 (block 812). The example 130 is then used to form a prompt 128 including the input query 116 for processing by at least one machine-learning model (block 814), e.g., an LLM 132. A query result 118 is then received based on the processing of the prompt by the at least one machine-learning model (block 816). In this way, the example 130 provides context for processing by the LLM 132, thereby improving accuracy and computational efficiency.

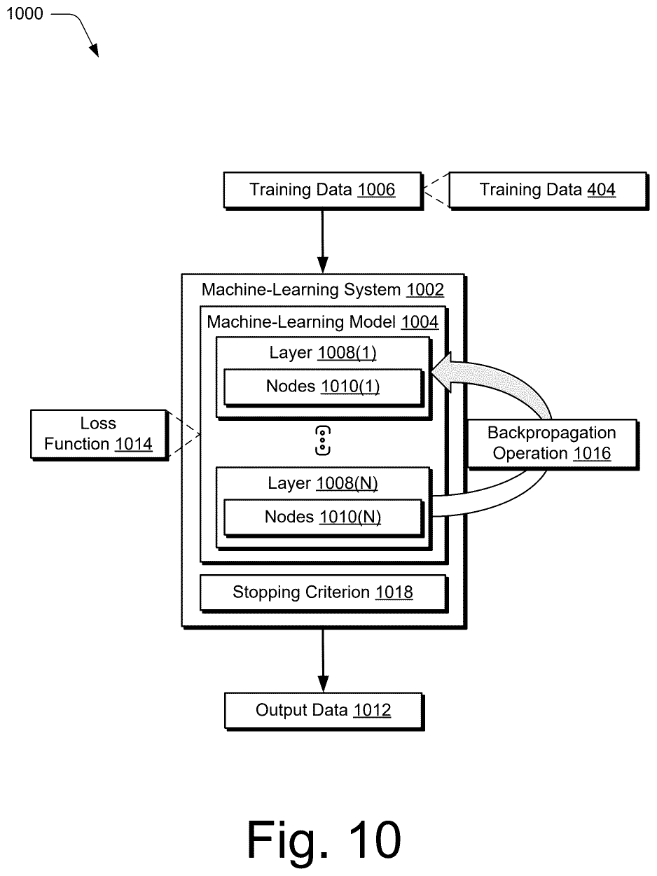

FIG. 10 depicts a system in an example implementation 1000 showing training of a machine-learning model of FIGS. 1 and 6 in greater detail. The machine-learning system 1002 implementation a machine-learning model 1004 as an example of the retriever machine-learning model 126. The machine-learning system 1002 is representative of functionality to generate training data 1006 (e.g., as an example of training data 404), use the generated training data 1006 to train the machine-learning model 1004, and/or use the machine-learning model 1004 as implementing the functionality described herein.

A machine-learning model 1004 refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

In the illustrated example, the machine-learning model 1004 is configured using a plurality of layers 1008(1), . . . , 1008(N) having, respectively, a plurality of nodes 1010(1), . . . , 1010(N). The plurality of layers 1008(1)-1011(N) are configurable to include an input layer, an output layer, and one or more hidden layers. Calculations are performed by the nodes 1010(1)-1010(N) within the layers via hidden states through a system of weighted connections that are “learned” during training of the machine-learning model 1004 to implement a variety of tasks.

In order to train the machine-learning model 1004, training data 1006 is received that provides examples of “what is to be learned” by the machine-learning model 1004, i.e., as a basis to learn patterns from the data. The machine-learning system 1002, for instance, collects and preprocesses the training data 1006 that includes input features and corresponding target labels, i.e., of what is exhibited by the input features. The machine-learning system 1002 then initializes parameters of the machine-learning model 1004, which are used by the machine-learning model 1004 as internal variables to represent and process information during training and represent interferences gained through training. In an implementation, the training data 1006 is separated into batches to improve processing and optimization efficiency of the parameters of the machine-learning model 1004 during training.

The training data 1006 is then received as an input by the machine-learning model 1004 and used as a basis for generating predictions based on a current state of parameters of layers 1008(1)-1008(N) and corresponding nodes 1010(1)-1010(N) of the model, a result of which is output as output data 1012. Output data 1012 describes an outcome of the task, e.g., as a probability of being a member of a particular class in a classification scenario.

Training of the machine-learning model 1004 includes calculating a loss function 1014 to quantify a loss associated with operations performed by nodes of the machine-learning model 1004. The calculating of the loss function 1014, for instance, includes comparing a difference between predictions specified in the output data 1012 with target labels specified by the training data 1006. The loss function 1014 is configurable in a variety of ways, examples of which include regret, Quadratic loss function as part of a least squares technique, and so forth.

Calculation of the loss function 1014 also includes use a backpropagation operation 1016 as part of minimizing the loss function 1014 and thereby training parameters of the machine-learning model 1004. Minimizing the loss function 1014, for instance, includes adjusting weights of the nodes 1010(1)-1010(N) in order to minimize the loss and thereby optimize performance of the machine-learning model 1004 in performance of a particular task. The adjustment is determined by computing a gradient of the loss function 1014, which indicates a direction to be used in order to adjust the parameters to minimize the loss. The parameters of the machine-learning model 1004 are then updated based on the computed gradient.

This process continues over a plurality of iteration in an example until a stopping criterion 1018 is met. The stopping criterion 1018 is employed by the machine-learning system 1002 in this example to reduce overfitting of the machine-learning model 1004, reduce computational resource consumption, and promote an ability of the machine-learning model 1004 to address previously unseen data, i.e., that is not included specifically as an example in the training data 1006. Examples of a stopping criterion 1018 include but are not limited to a predefined number of epochs, validation loss stabilization, achievement of a performance improvement threshold, or based on performance metrics such as precision and recall.

Configuration of the training data 1006 is usable to support a variety of usage scenarios. In one example, the training data 1006 is configured as training data 404 usable to train the retriever machine-learning model 126 to retrieve examples for inclusion in a prompt 128 with an input query 116 thereby providing context to the input query 116. A variety of other examples are also contemplated.

### Example System and Device

FIG. 11 illustrates an example system generally at 1100 that includes an example computing device 1102 that is representative of one or more computing systems and/or devices that implement the various techniques described herein. This is illustrated through inclusion of the query system 120. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The computer-readable storage medium is configured for storing instructions that, responsive to execution by the processing device, causes the processing device to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
locating, by a processing device, initial resource examples from an initial resource based on an input query;
locating, by the processing device, auxiliary resource examples from an auxiliary resource based on a similarity determination in an embedding space of the initial resource and the auxiliary resource; and
training, by the processing device, a retriever machine-learning model to retrieve examples from a resource based on an input query, the training including alternating, over a plurality of iterations:
training an initial retriever machine-learning model using the initial resource examples and an auxiliary retriever machine-learning model using the auxiliary resource examples; and
merging the initial retriever machine-learning model with the auxiliary retriever machine-learning model to train the retriever machine-learning model to implement a shared representation embedding space.

2. The method as described in claim 1, wherein the training the initial retriever machine-learning model and the auxiliary retriever machine-learning model is performed using an alternating minimization technique.

3. The method as described in claim 1, wherein the initial resource corresponds to a first human language and the auxiliary resource corresponds to a second human language.

4. The method as described in claim 3, further comprising selecting the auxiliary resource from a plurality of auxiliary resources.

5. The method as described in claim 1, wherein the training includes adjusting the retriever machine-learning model to implement diversity in the examples retrieved from the resource.

6. The method as described in claim 5, wherein the adjusting configures the retriever machine-learning model using a merged dataset of the initial resource examples and the auxiliary resource examples.

7. The method as described in claim 6, wherein the adjusting includes training the retriever machine-learning model based on the merged dataset by selecting a positive subset using maximum a posteriori (MAP) sampling and a negative subset using non-replacement random sampling.

8. The method as described in claim 1, wherein the training is performed over the plurality of iterations until a threshold level of convergence is reached as a stopping criterion.

9. The method as described in claim 1, further comprising detecting whether a threshold level of initial resource examples are available from an initial resource as sufficient for training the retriever machine-learning model to perform example generation and wherein the locating of the auxiliary resources examples from the auxiliary resource is performed responsive to the detecting that the threshold level of the initial resource examples is unavailable from the initial resource examples.

10. A computing device comprising:
a processing device; and
a computer-readable storage medium storing instructions that, responsive to execution by the processing device, causes the processing device to perform operations including:
receiving an input query;
generating an example from a first human language using a retriever machine-learning model based on the input query, the retriever machine-learning model trained using training data including initial resource examples from the first human language and auxiliary resource examples from a second human language;
forming a prompt for processing by at least one machine-learning module, the prompt based on the input query and the example; and
receiving a query result from the at least one machine-learning model in response to the prompt.

11. The computing device as described in claim 10, wherein the retriever machine-learning model is trained using an initial retriever machine-learning model trained using the initial resource example and an auxiliary retriever machine-learning model trained using the auxiliary resource examples.

12. The computing device as described in claim 11, wherein the initial retriever machine-learning model and the auxiliary retriever machine-learning model are trained using an alternating minimization technique and merged to form the retriever machine-learning model.

13. The computing device as described in claim 10, wherein the retriever machine-learning model is trained to implement sample diversity using a merged dataset of the initial resource examples and the auxiliary resource examples.

14. The computing device as described in claim 13, wherein the retriever machine-learning model is trained based on the merged dataset using positive subset sampled using maximum a posteriori (MAP) sampling and a negative subset sampled using non-replacement random sampling.

15. One or more computer-readable storage media storing instructions that, responsive to execution by a processing device, causes the processing device to perform operations comprising:
locating initial resource examples corresponding to a first language based on an input query;
detecting that a threshold level of the initial resource examples are unavailable from the first language that are sufficient for training a retriever machine-learning model to perform example generation;
identifying a second language by determining similarity with respect to the first language;
training an initial retriever machine-learning model trained using the initial resource examples and an auxiliary retriever machine-learning model trained using auxiliary resource examples from the second language; and
merging the initial retriever machine-learning model with the auxiliary retriever machine-learning model to cause the retriever machine-learning model to implement a shared representation embedding space to perform example generation.

16. The one or more computer-readable storage media as described in claim 15, wherein the training the initial retriever machine-learning model and the auxiliary retriever machine-learning model is performed using an alternating minimization technique.

17. The one or more computer-readable storage media as described in claim 15, wherein the operations further comprise selecting the auxiliary resource from a plurality of auxiliary resources.

18. The one or more computer-readable storage media as described in claim 15, wherein the operations further comprise adjusting the retriever machine-learning model to implement sample diversity.

19. The one or more computer-readable storage media as described in claim 18, wherein the adjusting configures the retriever machine-learning model using a merged dataset of the initial resource examples and the auxiliary resource examples.

20. The one or more computer-readable storage media as described in claim 19, wherein the adjusting includes training the retriever machine-learning model based on the merged dataset by selecting a positive subset using maximum a posteriori (MAP) sampling and a negative subset using non-replacement random sampling.
